(19) United States
(12) Patent Application Publication
(10) Pub. No.: US 2020/0001769 A1
(43) Pub. Date: Jan. 2, 2020

(54) LOCKING STRAP SYSTEM AND METHOD

(71) Applicant: Neal Joad, Cochrane (CA)

(72) Inventor: Neal Joad, Cochrane (CA)

(21) Appl. No.: 16/021,604

(22) Filed: Jun. 28, 2018

(51) Int. Cl. B60P 7/08; B66D 1/60; B60P 3/073

(52) U.S. Cl. CPC B60P 7/0846; B60P 1/00; B60P 3/073; B66D 1/60

(57) ABSTRACT

A locking strap system including: a locking strap assembly having a retracting and winding device with a main body, a winding shaft rotatably mounted on the main body, the winding shaft able to wind, in series, a length of webbed strapping, the webbed strapping able to be wound and alternately retracted sequentially based upon forces imparted on it wherein the webbed strapping when released is wound around the winding shaft via springs, a ratchet wheel which is rotatably mounted on the winding shaft, a pawl for selective engagement with the ratchet wheel for causing the springs to reduce a torque exerted to the winding shaft and hence reduce a retracting the force exerted to the webbed strapping, and wherein the locking strap system is configured to provide a safe means to secure a rollable object to prevent uncontrolled relative movement; the webbed strapping removably couplable to the rollable object.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of buckles, buttons, clasps of existing art and more specifically relates to cam levers.

### RELATED ART

Many individuals drive vehicles between locations for pleasure or for work. Many times, these vehicles may not work properly or be in an accident whereby the vehicle needs to be transported to a location for fixing the vehicle. Often times vehicles are towed via a strap or chain linked from one vehicle to another. This may be dangerous if the strap or chain becomes undone and is often illegal due to its dangerous nature. Trailers pulled by trucks may be used to transport vehicles however this requires two pieces of equipment and hooking and unhooking of the trailer from the truck. Tow trucks may also be used; some of these tow trucks may have a deck that may or may not tip for loading the vehicle. The tow trucks with tiltable decks are easier to load the vehicle however the vehicle may come unconnected from a winch or the like (catastrophic disconnect) and roll into on-coming traffic putting the operator of the tow truck, bystanders and/or motorists in danger. A suitable means to control any relative movement of the vehicle is desired in the interest of safety.

U.S. Pat. No. 5,548,873 to Isreal A. Macias relates to a self-locking cleat for rope, cable and the like. The described self-locking cleat for rope, cable and the like includes a housing, a rotatable generally spherically-shaped engaging member, a biasing means and a positioning means. The housing includes an elongated base, a first passageway generally circular in cross-section and extending transverse to the length of the base. A chamber is formed in the base and is disposed adjacent one side of the first passageway. A length of rope is drawn through the first passageway in either a first or an oppositely directed second direction. The rotatable engaging member is pivotally mounted within the chamber and is positionable at either a first or a second position. The member is biased into the first position by the biasing means and is manually positionable, via the positioning means, into the second position. When the member is in the first position it partially blocks the passageway and engagingly contacts the rope such that the rope may be freely drawn through the passageway in the first direction but not in the second direction. When the member is in the second position it does not block the passageway and does not engagingly contact the rope, such that the rope may be freely pulled through the passageway in either the first or the second directions.

### SUMMARY OF THE INVENTION

In view of the foregoing disadvantages inherent in the known cam lever art, the present disclosure provides a novel locking strap system. The general purpose of the present disclosure, which will be described subsequently in greater detail, is to provide an efficient and effective means to safely secure vehicles for loading and transport.

A locking strap system is disclosed herein comprising: a locking strap assembly having a retracting and winding device with a main body, a winding shaft rotatably mounted (able to travel in alternate directions as needed) on the main body; the winding shaft able to wind, in series, a length of webbed strapping. The webbed strapping is able to be wound and alternately retracted sequentially based upon forces imparted on it; wherein the webbed strapping, when released, is wound around the winding shaft via springs (or other suitable means). A ratchet wheel is rotatably mounted on the winding shaft. A pawl may be used in particular embodiments included for selective engagement with the ratchet wheel for causing the springs to reduce a torque exerted to the winding shaft and hence reduce a retracting force exerted to the webbed strapping. As such the locking strap system is configured to provide a safe means to secure a rollable object to prevent uncontrolled relative movement, the webbed strapping removably couplable to the rollable object. The device, when used, acts in a similar capacity as a seatbelt such that proper tension is realized to control relative movement of the vehicle being transported.

According to another embodiment, a method of use for the locking strap system is also disclosed herein. The method of use includes steps of, providing the locking strap system comprising: a locking strap assembly having a retracting and winding device with a main body, a winding shaft rotatably mounted on the main body, the winding shaft able to wind, in series, a length of webbed strapping, the webbed strapping able to be wound and alternately retracted sequentially based upon forces imparted on it wherein the webbed strapping when released is wound around the winding shaft via springs, a ratchet wheel which is rotatably mounted on the winding shaft, a pawl (optional) for selective engagement with the ratchet wheel for causing the springs to reduce a torque exerted to the winding shaft and hence reduce a retracting the force exerted to the webbed strapping, next step is coupling the locking strap assembly to a deck, followed by a step of removably coupling the length of webbed strapping to a rollable object (vehicle or other), attaching the webbed strapping to the rollable object, and then connecting a connection means (winch or other) mounted to the deck and connecting to the rollable object. The method may further comprise the steps of removing/unhooking the connection means between the deck and the rollable object followed by removing the webbed strapping from the rollable object and storing for later use. Some embodiments may have the present invention mounted to the deck and others may be removable.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a locking strap system, constructed and operative according to the teachings of the present disclosure.

FIG. 1 is a perspective view of the locking strap system during an ‘in-use’ condition, according to an embodiment of the disclosure.

FIG. 2 is another view of the locking strap system of FIG. 1, according to an embodiment of the present disclosure.

FIG. 3 is a perspective view of the locking strap system of FIG. 1, according to an embodiment of the present disclosure.

FIG. 4 is another perspective view of the locking strap system of FIG. 1, according to an embodiment of the present disclosure.

FIG. 5 is a flow diagram illustrating a method of use for the locking strap system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a cam lever and more particularly to a locking strap system as used to improve the safety of loading and transporting vehicles or other items that may roll.

Generally speaking the locking strap system would work much like a car seatbelt; it locks in place if a vehicle starts to roll back. Most ramp style tow trucks use a cable system to pull vehicles onto the angled ramp then once loaded the ramp is tilted back to its level position and the vehicle can be further secured. If the tow cable breaks this system prevents the vehicle from rolling back off the ramp and into oncoming traffic preventing accidents and/or injuries as previously mentioned. The system is based on technology (cam locks, seat belts) and is very cost effective to make and produce yet having different structure and functionality. If the tow cable breaks the system “locks” like a seat belt, the pressure of the vehicle holds the lock in place. It may be easily mounted and used on either side of the tow vehicle keep the operator safe (out of traffic) in virtually any tow scenario. It is easy to use, install, store, ship etc. Vehicles can gain a lot of speed if a tow cable breaks as the ramps are angled to almost 45 degrees, they could then roll into oncoming traffic or run over pedestrians which is one of the main problems the present invention serves to solve.

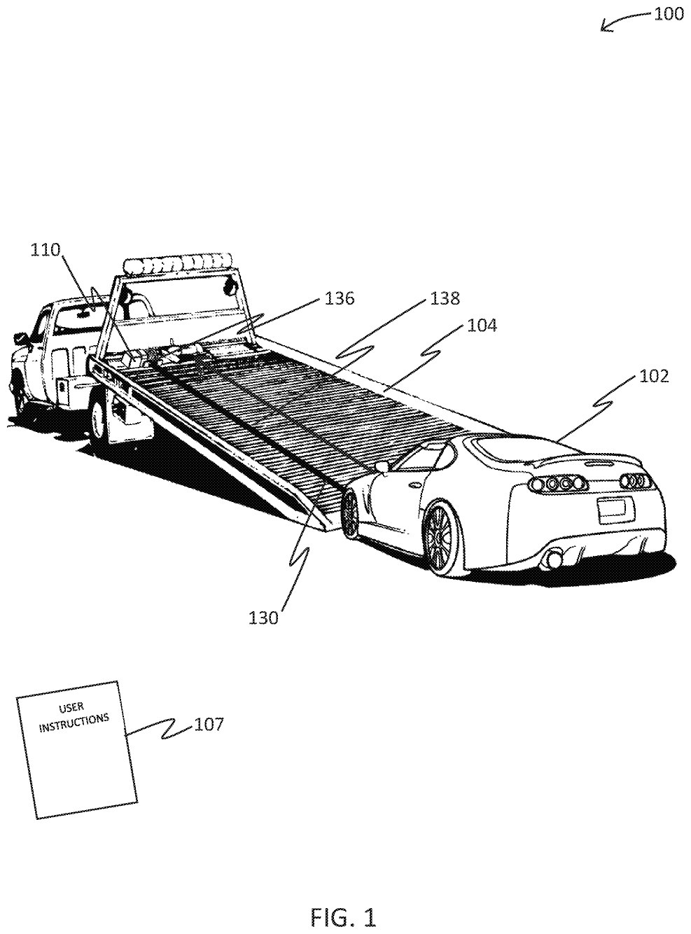

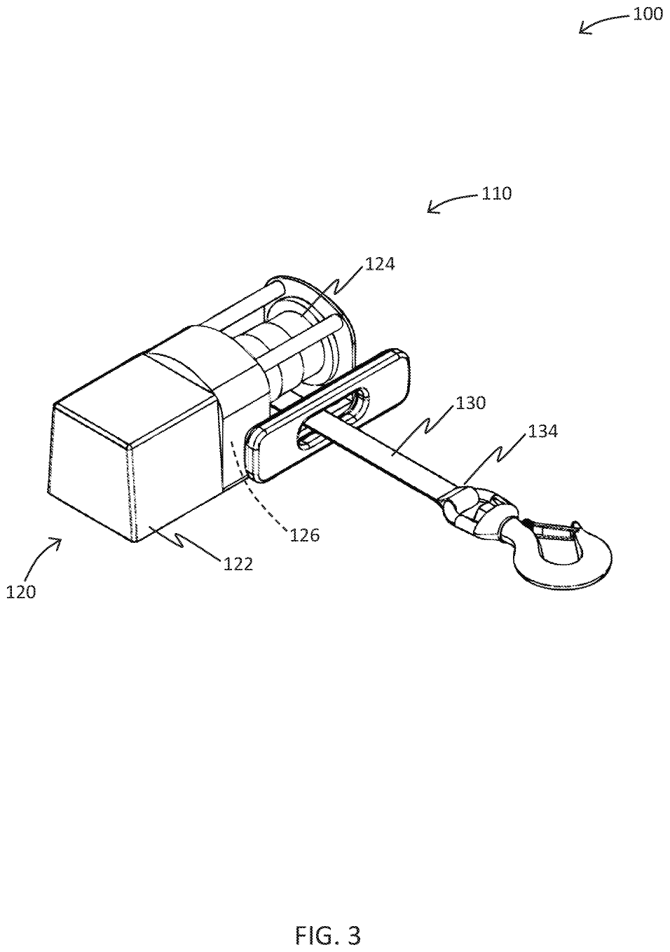

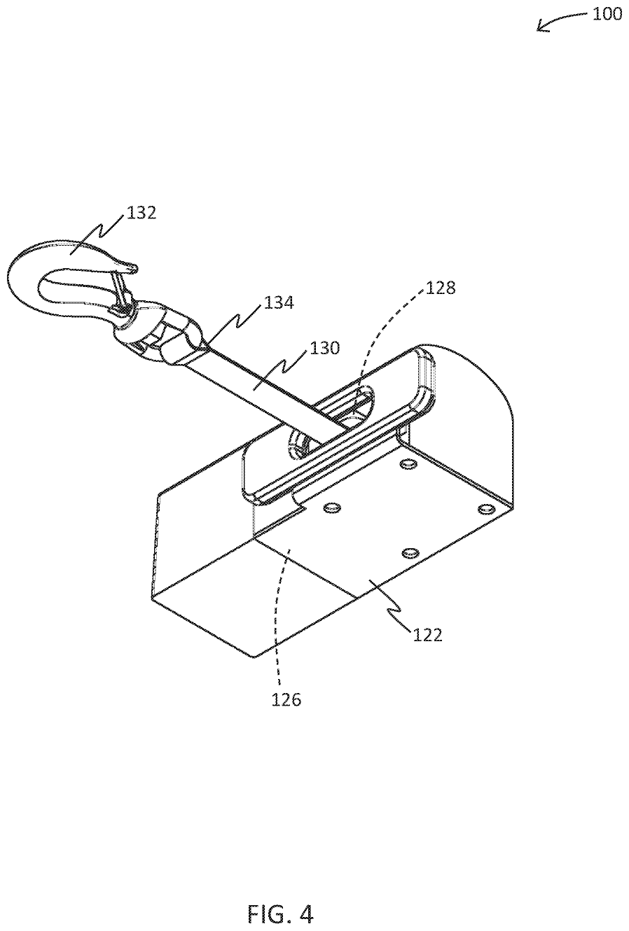

Referring now more specifically to the drawings by numerals of reference, there is shown in FIGS. 1-4, various views of a locking strap system 100.

FIG. 1 shows a locking strap system 100 during an ‘in-use’ condition 150, according to an embodiment of the present disclosure. Here, the locking strap system 100 may be beneficial for use by a user to prevent rolling of the vehicle 102 once so secured. As illustrated, the locking strap system 100 may include a locking strap assembly 110 having a retracting and winding device 120 with a main body 122, a winding shaft 124 rotatably mounted on the main body 122; the winding shaft 122 able to wind, in series, a length of webbed strapping 130; the webbed strapping 130 able to be wound and alternately retracted sequentially based upon forces imparted on it (force of the vehicle rolling back if the winch cable breaks or the like). The webbed strapping 130 when released is wound around the winding shaft 124 via springs (or other suitable means). A ratchet wheel 126 is rotatably mounted on the winding shaft 124. A pawl 128 is used for selective engagement with the ratchet wheel 126 for causing the springs to reduce a torque exerted to the winding shaft 124 and hence reduce a retracting the force exerted to the webbed strapping 130. The locking strap system 100, as such, is configured to provide a safe means to secure a rollable object (vehicle 102) to prevent uncontrolled relative movement, the webbed strapping 130 removably couplable to the rollable object (vehicle 102), as shown.

According to one embodiment, the locking strap system 100 may be arranged as a kit 105. In particular, the locking strap system 100 may further include a set of instructions 107. The instructions 107 may detail functional relationships in relation to the structure of the locking strap system 100 such that the locking strap system 100 can be used, maintained, or the like, in a preferred manner.

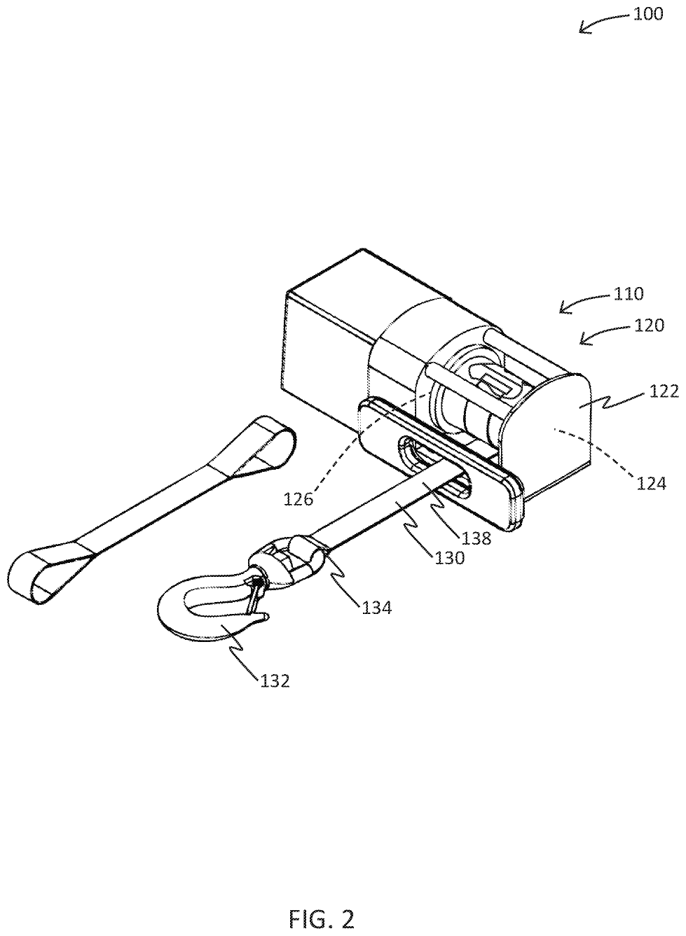

Referring now to FIGS. 2-4 showing various views of the locking strap system 100 of FIG. 1, according to an embodiment of the present disclosure. The webbed strapping 130 preferably comprises a hook 132 (or other suitable securing means) on a terminal end 134 of the webbed strapping 130 and a proximate end 136 of the webbed strapping 130 is leashed to the winding shaft 124. The terminal end 134 is located opposite (on the opposing end of) the proximate end 136 on the length 138 of the webbed strapping 130. The present invention serves to act in the capacity of a ‘seatbelt’ for vehicle 102. Those with ordinary skill in the art will now appreciate that upon reading this specification and by their understanding the art of seatbelts as described herein, methods of constructing, using, locking, unlocking, winding, unwinding, enabling desired forward and backward movement via springs, cams, locking, proper and secure connection to the vehicle being transported and to the deck being used for transport, etc will be understood by those knowledgeable in such art.

The rollable object comprises a vehicle 102 or the like; wherein the vehicle 102 is able to be coupled to a deck 104. The deck 104 may be a trailer-deck (not shown) or the deck 104 (shown in FIG. 1) may be mounted to a frame of a tow truck, as shown. The relative movement of vehicle 102 in relation to the deck 104 is limited to less than ½ of a foot of ‘slack’ (more or less is allowed) such that the webbed strapping 130 absorbs the rolling forces and stops the vehicle 102 from further movement. Coupling of the webbed strapping 130 to the rollable object occurs before a connection means to the deck 104 is performed. If the connection means to the deck 104 comes undone (uncoupled in some way) then the locking strap system 100 prevents the uncontrolled relative movement of the rollable object from occurring (in a rearward motion).

The winding shaft 124 comprises a cylindrical profile and the webbed strapping 130 comprises a flat profile; wherein the webbed strapping 130 (or the like) is able to be sequentially wound and unwound from the winding shaft 124. The pawl 128 is able to be manually operated by a user in certain embodiments; wherein the pawl 128 may comprise a lever; wherein the lever provides means to wind and alternately unwind the webbed strapping 130. The present invention may be manually or non-manually operated.

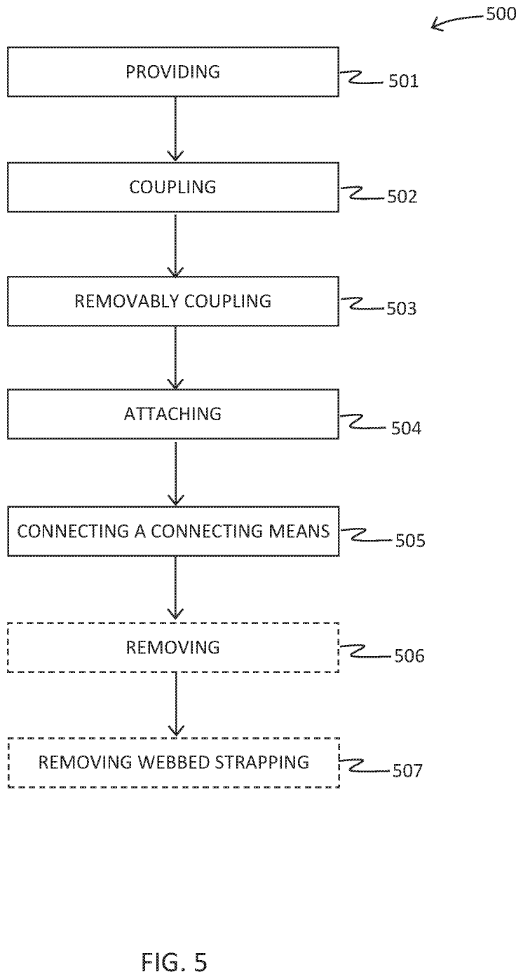

FIG. 5 is a flow diagram illustrating a method for using 500 the locking strap system 100, according to an embodiment of the present disclosure. In particular, the method for use 500 may include one or more components or features of the locking strap system 100 as described above. As illustrated, the method for using 500 the locking strap system 100 may include the steps of: step one 501, providing the locking strap system 100 (as described above); step two 502, coupling the locking strap assembly to a deck; step three 503, removably coupling the length of webbed strapping to a rollable object; step four 504 attaching the rollable object, step five 505 connecting a connection means to/between the deck and the rollable object. Optional steps may include step six 506 and seven 507 respectively, removing the connection means to the deck and the rollable object followed by removing the webbed strapping from the rollable object.

It should be noted that steps 507-508 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for installation, storage and the like are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A locking strap system comprising:
a locking strap assembly having
a retracting and winding device with
a main body;
a winding shaft rotatably mounted on said main body, said winding shaft able to wind, in series, a length of webbed strapping, said webbed strapping able to be wound and alternately retracted sequentially based upon forces imparted on it wherein said webbed strapping when released is wound around said winding shaft via springs;
a ratchet wheel which is rotatably mounted on said winding shaft;
a pawl for selective engagement with said ratchet wheel for causing said springs to reduce a torque exerted to said winding shaft and hence reduce a retracting said force exerted to said webbed strapping; and
wherein said locking strap system is configured to provide a safe means to secure a rollable object to prevent uncontrolled relative movement, said webbed strapping removably couplable to said rollable object.

2. The locking strap system of claim 1, wherein said webbed strapping comprises a hook on a terminal end of the webbed strapping.

3. The locking strap system of claim 2, wherein a proximate end of said webbed strapping is leashed to said winding shaft.

4. The locking strap system of claim 3, wherein said rollable object comprises a vehicle.

5. The locking strap system of claim 4, wherein said vehicle is able to be coupled to a deck.

6. The locking strap system of claim 5, wherein said deck is a trailer-deck.

7. The locking strap system of claim 5, wherein said deck is mounted to a frame of a truck.

8. The locking strap system of claim 5, wherein said relative movement is limited to less than ½ of a foot.

9. The locking strap system of claim 3, wherein the terminal end is located opposite said proximate end on said length of said webbed strapping.

10. The locking strap system of claim 1, wherein the winding shaft comprises a cylindrical profile.

11. The locking strap system of claim 1, wherein the webbed strapping comprises a flat profile.

12. The locking strap system of claim 5, wherein coupling of said webbed strapping to said rollable object occurs before a connection means to said deck is performed.

13. The locking strap system of claim 12, wherein if the connection means to said deck comes undone then said locking strap system prevents said uncontrolled relative movement of said rollable object from occurring.

14. A locking strap system comprising:
a locking strap assembly having
a retracting and winding device with
a main body;
a winding shaft rotatably mounted on said main body, said winding shaft able to wind, in series, a length of webbed strapping, said webbed strapping able to be wound and alternately retracted sequentially based upon forces imparted on it wherein said webbed strapping when released is wound around said winding shaft via springs;
a ratchet wheel which is rotatably mounted on said winding shaft;
a pawl for selective engagement with said ratchet wheel for causing said springs to reduce a torque exerted to said winding shaft and hence reduce a retracting said force exerted to said webbed strapping; and
wherein the webbed strapping comprises a flat profile;
wherein said webbed strapping comprises a hook on a terminal end of the webbed strapping;
herein a proximate end of said webbed strapping is leashed to said winding shaft;
wherein the terminal end is located opposite said proximate end on said length of said webbed strapping;
wherein said locking strap system is configured to provide a safe means to secure a rollable object to prevent uncontrolled relative movement, said webbed strapping removably couplable to said rollable object;
wherein said relative movement is limited to less than ½ of a foot;
wherein said rollable object comprises a vehicle;
wherein said vehicle is able to be coupled to a deck;
wherein coupling of said webbed strapping to said rollable object occurs before a connection means to said deck is performed; and
wherein if the connection means to said deck comes undone then said locking strap system prevents said uncontrolled relative movement of said rollable object from occurring.

15. The locking strap system of claim 14, further comprising set of instructions; and
wherein the locking strap system is arranged as a kit.

16. A method of use for a locking strap system, the method comprising the steps of:
providing the locking strap system comprising:
a locking strap assembly having
a retracting and winding device with
a main body;
a winding shaft rotatably mounted on said main body, said winding shaft able to wind, in series, a length of webbed strapping, said webbed strapping able to be wound and alternately retracted sequentially based upon forces imparted on it wherein said webbed strapping when released is wound around said winding shaft via springs;
a ratchet wheel which is rotatably mounted on said winding shaft;
coupling said locking strap assembly to a deck;
removably coupling said length of webbed strapping to a rollable object;
attaching said rollable object; and
connecting a connection means to said deck and said rollable object.

17. The method of claim 16, further comprising the steps of removing said connection means to said deck and said rollable object followed by removing said webbed strapping from said rollable object.
